(19) United States
(12) Patent Application Publication
(10) Pub. No.: US 2013/0076006 A1
(43) Pub. Date: Mar. 28, 2013

(54) DEVICE FOR POSITIONING WHEELED TRANSPORT LANDING GEAR LEGS(S) METHODS AND INVENTION

(71) Applicant: Kevin Falconer, Mississauga (CA)

(72) Inventor: Kevin Falconer, Mississauga (CA)

(21) Appl. No.: 13/602,173

(22) Filed: Sep. 2, 2012

Related U.S. Application Data
(60) Provisional application No. 61/575,936, filed on Sep. 1, 2011.
(60) Provisional application No. 61/660,037, filed on Jun. 15, 2012.

(51) Int. Cl. B60S 9/04; B62D 53/08

(52) U.S. Cl. CPC B60S 9/04; B62D 53/08
USPC 280/433; 280/763.1

(57) ABSTRACT

Disclosed is a landing gear including a leg, a foot, an indexing member, a mounting structure and a calibration structure. The leg extends downwardly in use and defines a longitudinal axis. The foot is operatively mounted to the leg for axial movement between a retracted position proximal to the leg and an extended position distal to the leg. The indexing member, in use, is operatively connected to the leg. The mounting structure, in use, is operatively connected to the foot. The calibration structure is connected to the mounting structure and, in use, extends axially alongside the leg. The landing gear can facilitate drop and pick-up of highway trailers.

### CROSS-REFERENCE TO RELATED APPLICATIONS

This Application claims the benefit of U.S. Provisional Application 61/575,936 filed on Sep. 1, 2011. This Application claims the benefit of U.S. Provisional Application 61/660,037 filed on Jun. 15, 2012.

### FIELD OF THE INVENTION

The invention relates to the field of trailers.

### BACKGROUND OF THE INVENTION

It is well known to move goods through the use of a highway tractor hauling a loaded highway trailer. Loading and unloading the contents of a highway trailer can be time-consuming, and the run-time cost of a highway trailer is significantly less than the run-time cost of a tractor and tractor-operator. Accordingly, it is often unproductive to have the tractor and operator idled during loading/unloading. For this reason: carriers often maintain an inventory of trailers that greatly exceeds the inventory of tractors and operators; trailers are allowed to sit idle pending loading/unloading; and tractors and operators are shifted from location to location to maintain maximum productivity, shunting trailers as required. This arrangement works well, but it will be appreciated that this requires a great deal of coupling and uncoupling of tractors and trailers. Accordingly, wear and tear associated with the king pins and fifth wheels in this industry is relatively high.

### SUMMARY OF THE INVENTION

Forming one aspect of the invention is an improved trailer of the type for use with a tractor. The tractor is of the type having a fifth wheel movable between up and down positions. The trailer is of the type having: a wheeled carriage; a king pin mounted to and extending downwardly from the underside of the carriage for coupling with the fifth wheel; and a pair of landing gear.

Each of the pair of landing gear includes: an elongate leg extending downwardly from the underside of the carriage and defining a longitudinal axis; and a foot operatively mounted to the leg for longitudinal movement between a retracted position proximal to the leg and an extended position distal to the leg.

In this aspect of the invention, the improvement comprises: an indexing member which, in use, is operatively connected to the leg; a mounting structure which, in use, is operatively connected to the foot; and a calibration structure connected to the mounting structure and which, in use, extends axially alongside the leg.

Each of the landing gear has an operative configuration, wherein: when the carriage is supported by the landing gear and the fifth wheel of the tractor is in the down position, the tractor can be driven underneath the carriage to permit smooth engagement and smooth disengagement of the fifth wheel and the king pin; and when the fifth wheel and king pin are engaged, movement of the fifth wheel from the down position to the up position elevates the foot from the ground.

According to other aspects of the invention:
in respect of each of the landing gear, the calibration structure can have a sweet spot which is aligned with the indexing member when said each landing gear is in the operative configuration; and
a marker can be associated in use with the sweet spot and adapted to facilitate visual alignment of the sweet spot and the indexing member.

According to another aspect of the invention, the marker can be releasably connected to the sweet spot in use.

According to another aspect of the invention, the calibration structure can be a rod, the sweet spot can be associated with a peripheral groove in the rod and the marker can be a spring clip.

According to another aspect of the invention, the indexing member, in use, can be connected to the leg; the mounting structure, in use, can be connected to the foot; and the calibration structure can be a rod.

Forming another aspect of the invention is apparatus comprising: a landing gear, an indexing member, a mounting structure and a calibration structure. In this apparatus,
the landing gear includes: a leg which extends downwardly in use and defines a longitudinal axis; and a foot operatively mounted to the leg for axial movement between a retracted position proximal to the leg and an extended position distal to the leg
the indexing member, in use, is operatively connected to the leg;
the mounting structure is operatively connected to the foot; and
the calibration structure is connected to the mounting structure and, in use, extends axially alongside the leg.

According to other aspects of the invention, in this apparatus a marker can also be provided, the marker being adapted to facilitate visual alignment of the marker and the indexing member and being releasably connected to the calibration structure in use.

According to another aspect of the invention, in this apparatus, the calibration structure can have a plurality of securement locations which are axially-spaced from one another in use; and the marker can be adapted for releasable connection to any selected one of the securement locations, thereby to provide for said releasable connection of the marker to the calibration structure in use.

Forming yet another aspect of the invention is a kit for use with a variety of trailer-tow vehicle combinations. In each combination (i) the tow vehicle has one of a hitch and a hitch receiver; and (ii) the trailer has: the other of the hitch and the hitch receiver; and a landing gear. The landing gear includes: an elongate leg extending downwardly from the trailer and defining a longitudinal axis; and a foot operatively mounted to the leg for axial movement between a retracted position proximal to the leg and an extended position distal to the leg.

This kit comprises:
an indexing member which, in use, is operatively connected to the leg of the landing gear of any one of the variety of trailers;
a mounting structure which, in use, is operatively connected to the foot of said landing gear;
a calibration structure connected to the mounting structure; which, in use, extends axially alongside the leg of said landing gear; and has a plurality of axially-spaced securement locations associated therewith; and
a marker adapted: to facilitate visual alignment of the marker and the indexing member; and for releasable connection to the calibration structure at any selected one of the securement locations.

In the context of the use of the kit with any one of the combinations, it will be appreciated that:
the landing gear of the trailer of said combination has an operative configuration wherein the trailer is supported by the landing gear such that other of the hitch and hitch receiver is at a height optimized for engagement of the one of the hitch and hitch receiver therewith;
the calibration structure has a sweet spot which is aligned with the indexing member when the landing gear is in the operative configuration; and
the marker can be secured to the one of the securement locations closest to the sweet spot to facilitate visual alignment of the sweet spot with the indexing member, thereby to approximate the operative configuration of the landing gear and facilitate engagement and disengagement of the hitch and hitch receiver.

According to another aspect of the invention, the calibration structure can be a rod, the securement locations can be defined by respective peripheral grooves in the rod and the marker can be a spring clip.

Other advantages, features and characteristics of the invention will become more apparent upon consideration of the following description and appended claims with reference to the accompanying drawings, the latter being briefly described hereinafter.

### BRIEF DESCRIPTION OF THE DRAWINGS

FIG. 1 is a side plan view of a tractor trailer combination of the prior art, with the landing gear of the trailer in the transport positions and the fifth wheel of the tractor in the up position and engaged with the king pin of the trailer;

FIG. 2 is a view similar to FIG. 1, with the landing gear in the operative configuration;

FIG. 3 is a view similar to FIG. 2, with the fifth wheel in the down position;

FIG. 4 is a view similar to FIG. 3, with the fifth wheel disengaged from the king pin;

FIG. 5 is a view of a trailer according to an exemplary embodiment of the invention in use with a prior art tractor, in a manner analogous to FIG. 1;

FIG. 5A is an isometric view of the structure of encircled area 5A in FIG. 5;

FIG. 6 is a view of the structure of FIG. 5, with the landing gear in the operative configuration;

FIG. 6A is an isometric view of the structure of encircled area 6A in FIG. 6;

FIG. 7 is a view of the structure of FIG. 6, with the fifth wheel in the down position; and

FIG. 8 is a view of the structure of FIG. 7, with the fifth wheel disengaged from the king pin.

FIG. 9 is a side view, similar to FIG. 5A, of a further alternative embodiment;

FIG. 10 is a section along 10-10 of FIG. 9; and

FIG. 11 is a section along 11-11 of FIG. 9.

### DETAILED DESCRIPTION OF THE PREFERRED EMBODIMENTS

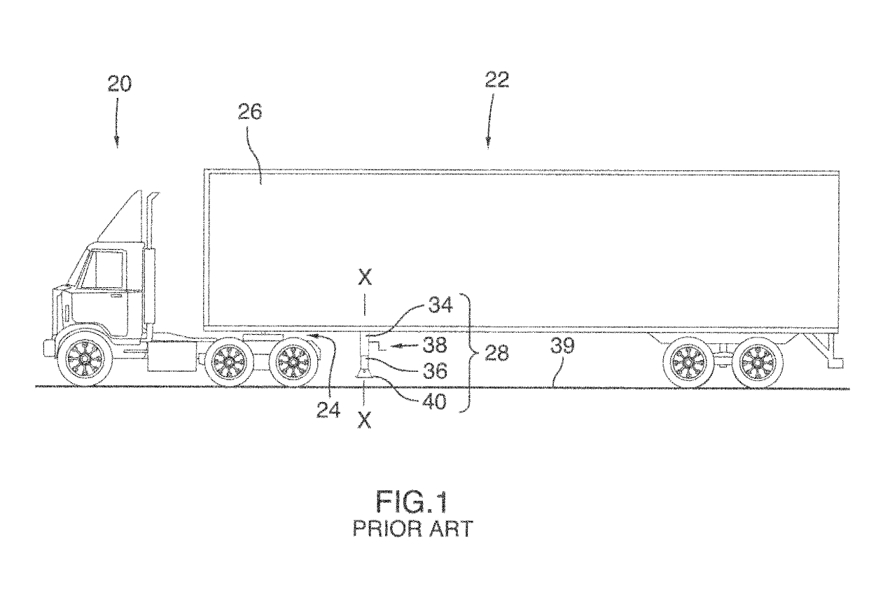

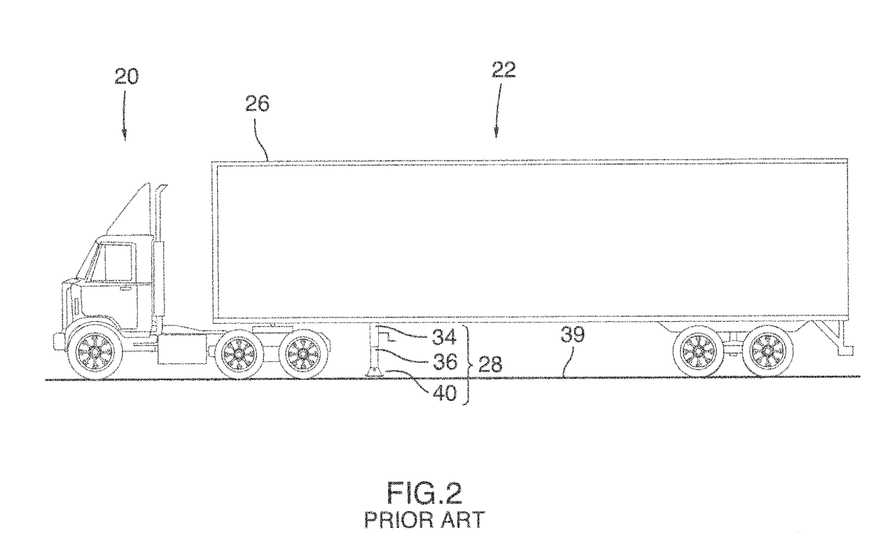

The exemplary embodiment of the present invention mentioned in the Summary of the Invention is described in detail hereinafter, but as an initial matter, focus is initially directed to FIGS. 1-4, which show germane portions of an exemplary prior art tractor and trailer combination.

### In the Prior Art

With reference to FIG. 1, there will be seen a prior art tractor 20 and prior art trailer 22, as aforementioned.

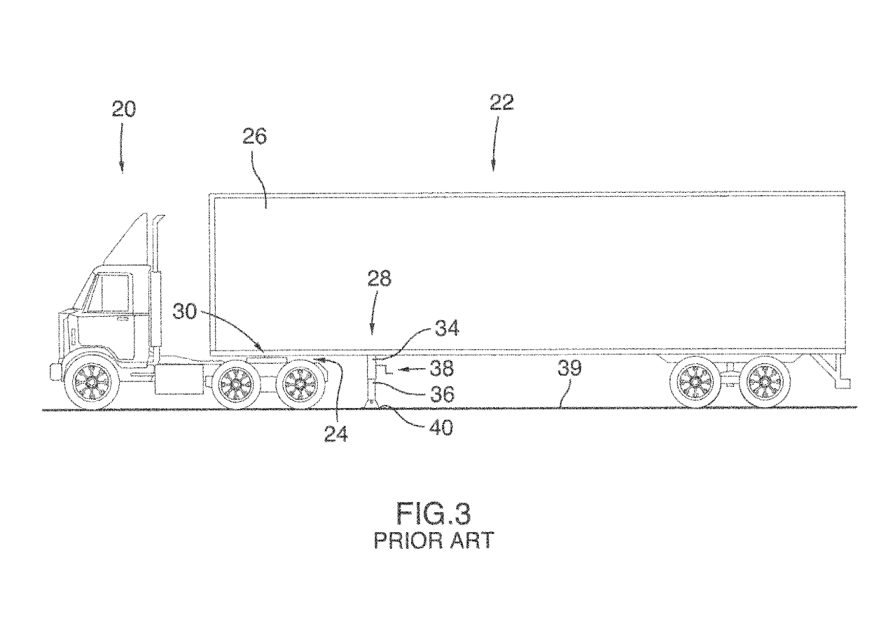

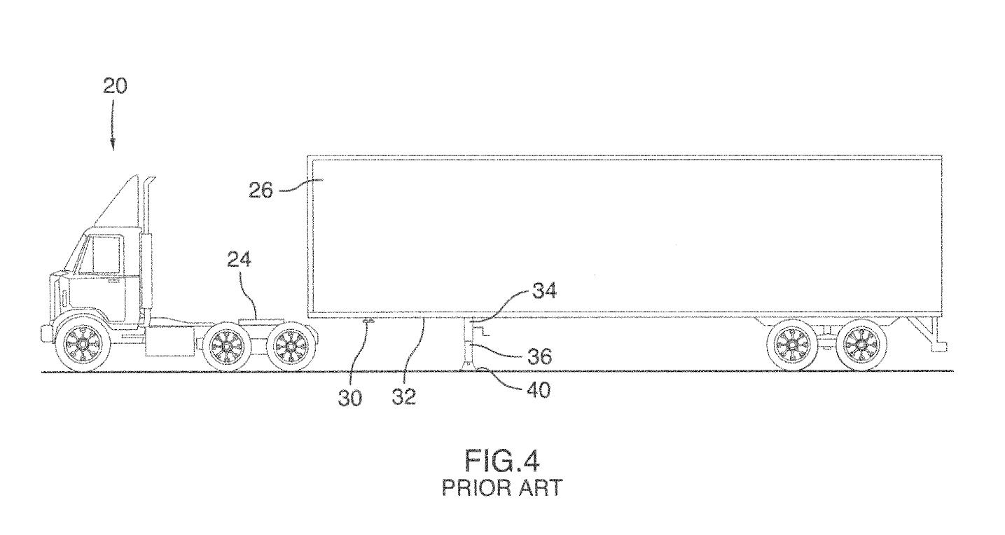

The tractor 20 will be understood to be of the type having a fifth wheel 24 movable between up and down positions, as indicated by the sequence of FIGS. 2 and 3.

The trailer 22 is of the common highway type having a wheeled carriage 26, landing gear 28 for supporting the carriage and, as best seen in FIG. 4, a king pin 30 mounted to and extending downwardly from the underside 32 of the carriage 26.

The landing gear 28 will be seen to comprise a leg 34, an extension 36, a crank 38 and a foot 40.

The leg 34 is elongate, defines an axis X-X and extends downwardly from carriage 26.

The extension 36 is an elongate member mounted telescopically within the leg 34 for movement between an extended position and a retracted position. The motion is evidenced by the sequence of FIGS. 2-3.

The crank 38 is coupled to a conventional crank actuator, not shown, to provide for said telescopic movement of the extension 36.

The foot 40 is mounted to the extension 36 for longitudinal movement, between a retracted position proximal to the leg 34 and associated with the retracted position of the extension 36 and an extended position distal to the leg 34 and associated with the extended position of the extension 36.

The sequence of FIGS. 1-4 shows the steps associated with an idealized trailer drop.

In FIG. 1, the combination 20,22 has been brought to a standstill. In this Figure:
the king pin (not visible) is engaged by the fifth wheel 24
the fifth wheel 24 is in the up position, via inflation of the suspension [not shown], to provide for ride comfort and minimize wear and tear on the tractor 20; and
the landing gear 28 are in a transport position, that is, the feet 40 are sufficiently retracted so as to avoid interference with the road surface 39.

In FIG. 2, the landing gear 28 have been reconfigured, into the operative configuration mentioned in the Summary of the Invention and discussed in detail hereinafter. In this position, the feet 40 will be seen to be slightly elevated above the ground 39.

In FIG. 3, the fifth wheel suspension (not shown) has been deflated, such that the fifth wheel 24 has transitioned to the down position. This has lowered the trailer 22, and the feet 40 will now be seen to be engaging the ground 39.

In FIG. 4, the tractor 20 will be seen to have driven forward, thereby releasing the king pin 30 from the fifth wheel 24.

It has been previously indicated above that the sequence of FIGS. 1-4 show an idealized trailer drop. In this regard, it will be recalled that, for any given trailer on level ground, there will be a unique operative configuration of the landing gear wherein:
i. when the carriage is supported by the landing gear and the fifth wheel of the tractor is in the down position, the tractor can be driven underneath the carriage to permit smooth engagement and smooth disengagement of the fifth wheel and the king pin; and
ii. when the fifth wheel and king pin are engaged, movement of the fifth wheel from the down position to the up position elevates the feet from the ground.

If (i) and (ii) are present: the operator is not required to manually extend or retract the landing gear under load, which is advantageous from the standpoint of wear and tear on both the operator and the landing gear; and wear and tear on the fifth wheel and king pin is reduced.

The sequence of FIGS. 1-4 is indicated as idealized because, although it is possible for the landing gear to be positioned in the operative configuration as shown, in the context of conventional landing gear, (i) and (ii) are often not present, as operators judge distances by eye. Thus, in the prior art, operators are often hand cranking landing gear under load, and engagement and disengagement of the king pin and the fifth wheel is often not smooth.

The present invention provides a mechanism which can improve the likelihood that (i) and (ii) are present.

### The Exemplary Embodiment

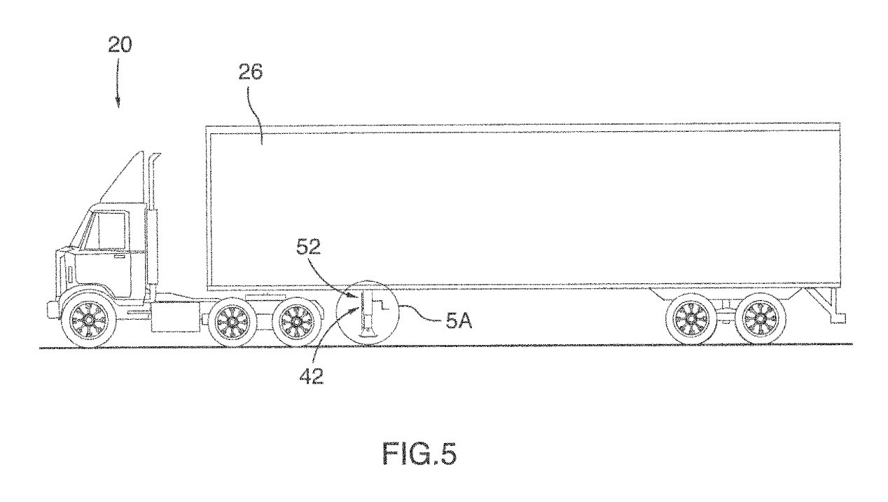

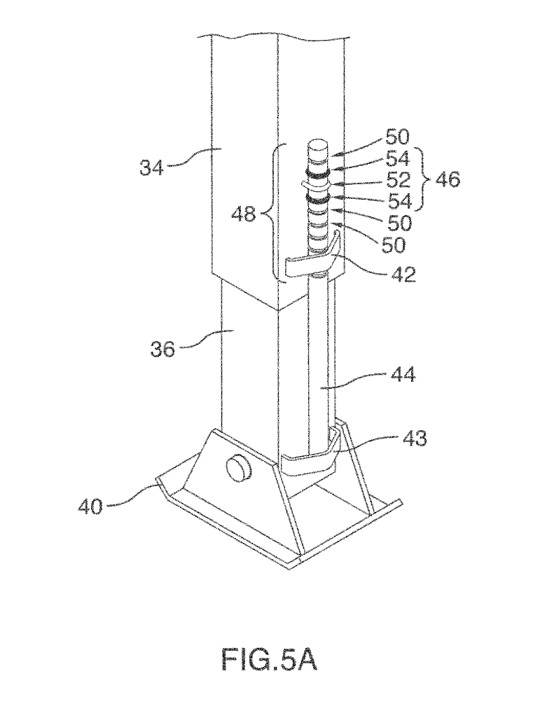

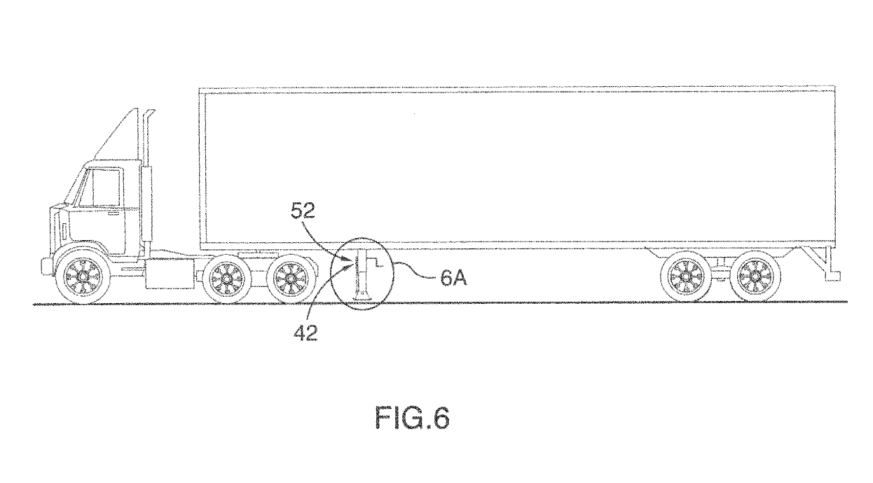

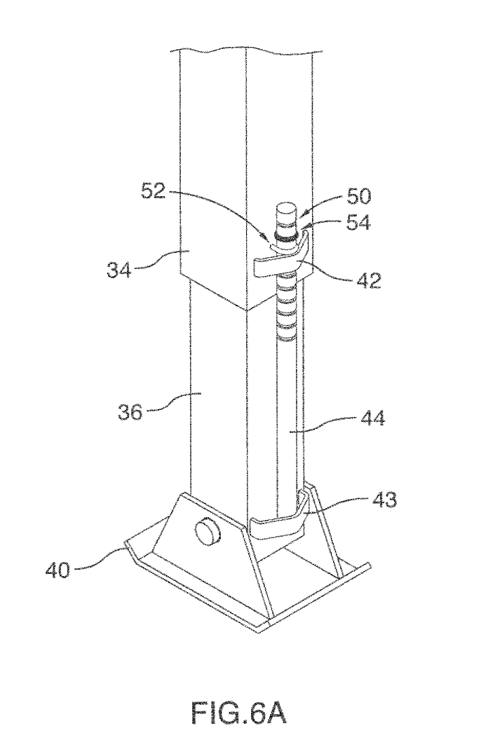

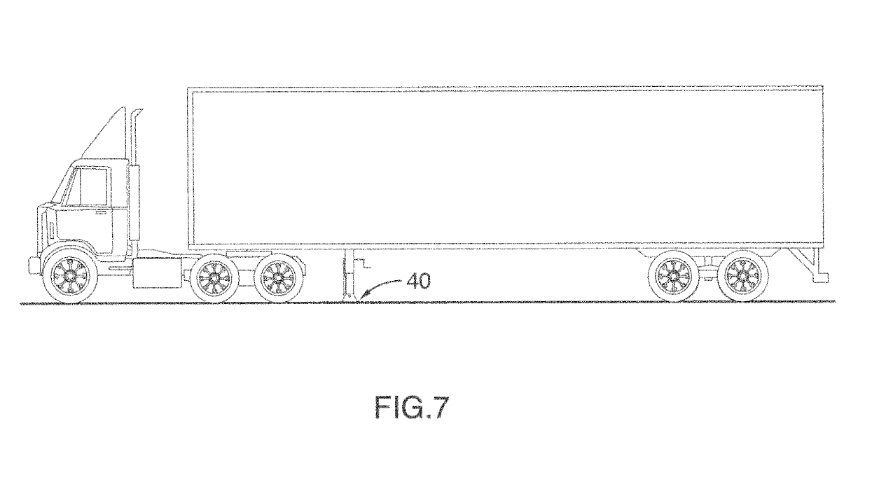

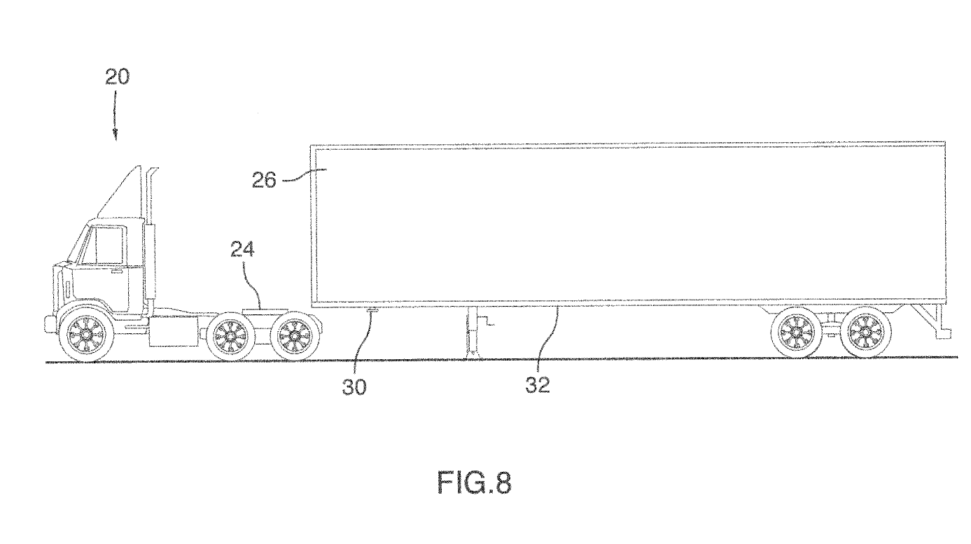

In this regard reference is now made to FIGS. 5 and 5A which shows the exemplary embodiment and will be seen to be identical to the structure of FIG. 1, but for an indexing member 42, a mounting structure 43, a calibration structure 44 and a marker arrangement 46.

The indexing member 42 will be seen to be a lug welded to the leg 34.

The mounting structure 43 will be seen to be another lug welded to the extension 36 [and thus operatively connected to the foot 40].

The calibration structure 44 will be seen to be in the form of a rod connected to the mounting structure 43 and having an alignment area 48 in which a plurality of peripheral grooves 50 are defined and which extends axially alongside the leg 34 and through and beyond the indexing lug 42.

The marker arrangement 46 will be seen to be defined by a marker, namely, a spring clip 52 and a pair of o-rings 54, the spring clip 52 being releasably connected into one of the peripheral grooves and the o-rings 54 engaged in axially flanking adjacent grooves.

### Operation on Level Ground

The operation of the trailer of the exemplary embodiment is shown in the sequence of FIGS. 5,6,7,8, which will be seen to be analogous to FIGS. 1-4.

However, whereas in the prior art, the operator gauged the distance of the feet 40 from the ground by eye, in the exemplary embodiment, the operator lowers the feet 40 until the marker 52 is aligned with the indexing member 42, as shown by the sequence of FIGS. 5,6 [and by the sequence of FIGS. 5A,6A] thereby to reliably bring the landing gear 28 to the operative configuration.

From this, it will be understood that the grooves 50 define a plurality of securement locations and the spring clip 52 is engaged in the groove that is nearest a “sweet spot” on the calibration structure 44, which is aligned with, i.e. immediately above, the indexing lug 42 when the associated landing gear 28 is in the operative configuration.

### Operation on Uneven Surfaces

In the context of inclined surfaces, such as loading ramps, wherein the landing gear need to be extended beyond the operative configuration, the spring clip can be removed, so as to avoid interference; the operator can easily replace spring clip in the appropriate location at a subsequent time, using the flanking a-rings as the guide for this step.

### Application

The exemplary indexing member, mounting structure, calibration structure and marker arrangement are usefully be packaged as a kit, with the indexing member and mounting structure being welded on a retrofit basis to conventional trailer landing gear. Herein, it will be understood that the plurality of peripheral grooves in the calibration structure has particular advantage, since the final position of the indexing member and mounting structure on the landing gear with which the kit is to be used may need to vary, depending upon the specific geometry of said landing gear. Once the various components are welded in place, the spring clip and the o-rings are fitted in the appropriate positions. To do this, the installer will first place the landing gear in the operative configurations. This is done on a trial and error basis. On level ground, and with the fifth wheel in the up position, the installer extends the landing gear to a position whereat the feet are about ½″ above the ground; moves the fifth wheel to the down position; and drives the tractor away. If the fifth wheel smoothly decouples from the king pin, the operation was successful. If the trailer traverses the sliders of the fifth wheel, the operation was unsuccessful and can be repeated as required.

Once the operation has been successfully completed, the installer simply releasably engages the spring clip in the one of the grooves that is immediately upwardly adjacent the indexing lug, and fits the o-rings in the adjacent, axially-flanking grooves.

### Variations

Numerous variations are possible.

For example, whereas the exemplary embodiment shows a highway tractor and van trailer combination, the invention could be useful in the context of other tractors and other trailers, including camper trailers. As well, whereas the exemplary embodiment shows a king pin and fifth wheel arrangement, the usefulness of the invention extends beyond this and can be used with any hitch and hitch receiver combination wherein there is a height for the one of the hitch and hitch receiver carried by the trailer which facilitates engagement and/or disengagement.

As well, whereas spring clips and o-rings are shown other visually apparent indicia can be substituted therefor. Additionally, it can be useful to chain or otherwise secure the spring clip to the device, to avoid loss.

Further, the invention need not be embodied with releasably securable markers: in the context of OEM trailers, the invention could be embodied, for example, with the marker permanently secured at the sweet spot, the indexing member mounted to the carriage [and thereby operatively secured to the leg] and the marker and indexing member being arranged such that the landing gear could extended beyond the operative configuration without interference.

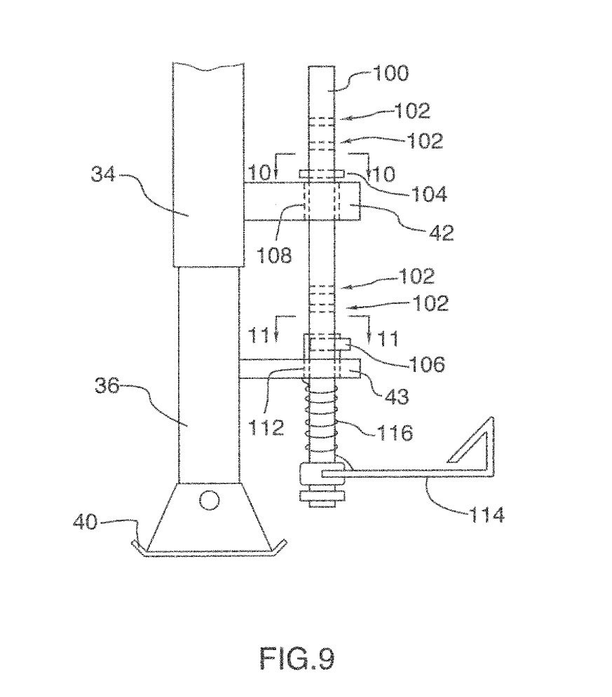

Another embodiment is shown in FIGS. 9-11.

This structure works similarly to the structure of FIGS. 5 and 5A and similarly includes an indexing member, a mounting structure, a calibration structure and a marker arrangement, but the elements herein are embodied differently to produce additional functionality, as discussed below.

The indexing member is again defined by an upper lug 42 welded to the leg 34.

The mounting structure includes another lower lug 43 welded to the extension 36 [and thus operatively connected to the foot 40].

The calibration structure is a rod 100 mounted having a plurality of bores 102 defined therewithin [indicated in phantom in FIG. 9].

The marker arrangement herein is defined by a pair of pins 104,106.

Also provided is: an upper guide defined by a tube 108 having defined, in one end, a slot 110; a lower guide defined by a tube 112 having a notched end 112A; a kick arm 114 rigidly mounted to the rod 100; and a spring 116 rigidly secured at one end to the kick arm 114 and at the other end to the lower lug 43. The upper and lower guides are secured by welds 120 to the upper 42 and lower 43 lugs. The slot 110 in the upper guide tube 108 presents upwardly. The lower guide is positioned such that only the notched out portion 112A extends above the lower lug 43. The rod 100 is mounted for axial and rotational movement in the upper and lower guides.

In use, the apparatus is calibrated in a manner analogous to the calibration of the embodiment of FIGS. 5 and 5A, namely, one of the pins 104 is driven into the bore that is immediately above the upper lug 42 when the landing gear is in the operative configuration. This provides for functionality identical to that previously described.

However, in addition, the other of the pins 106 is driven through that one of the bores that is horizontally aligned with the notched end 112A and is uppermost in the rod 100, such that the rod 100 is biased for rotational movement by the spring to a position whereat the other pin 106 bears against the notched end 112A.

The arrangement of the pins 104,106, bores 102 and guides is such that:
when the rod 100 is positioned such that the other pin 106 bears against the notched end of the lower guide tube, that is, the typical situation, overextension of the landing gear causes the upper pin 104 to bear against the upper guide tube 108;
if the drop point for the trailer is an angled dock, wherein the landing gear needs to be overextended beyond the sweet spot, the operator can kick the arm 114 to turn the rod 100 [against the force of the spring] until the upper pin 104 is aligned with, and enters the slot 110; the landing gear can then be extended the length of the slot 110, typically about 3″
after the trailer has been recoupled, the landing gear is retracted in the conventional manner, with the exception that, once the upper pin 104 clears the slot 110, the recoil spring 116 rotates the rod 100 until the lower pin 106 abuts the lower guide tube 112, ie, the position shown in FIG. 11, thereby to automatically reset the apparatus for use on level ground

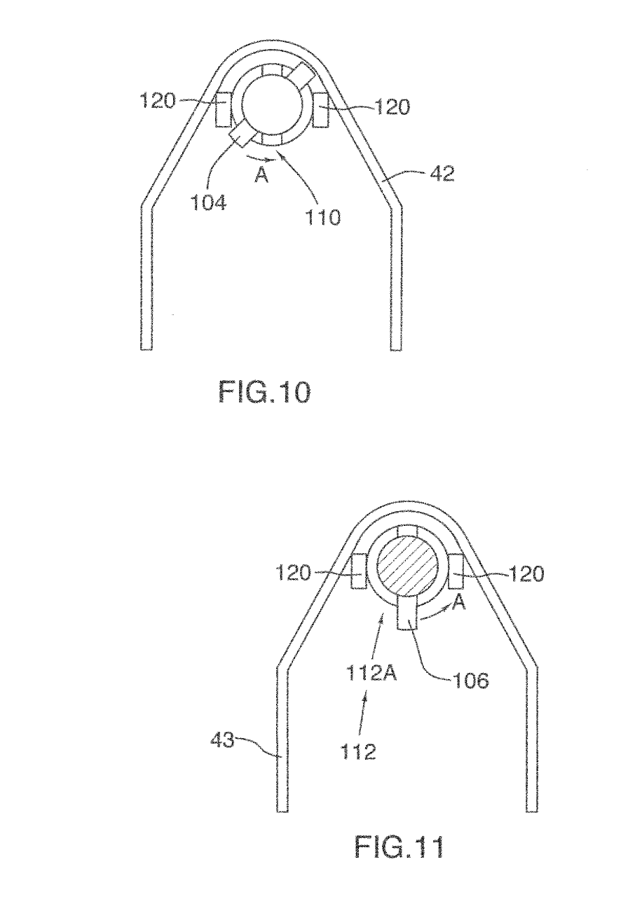

FIG. 10 shows the upper pin 104 offset from the slot 110; it will be evident that rotation of the pin 104 will bring same into alignment with the slot 110, thereby to permit entry as indicated above.

FIG. 11 shows the lower pin 106 abutting the notched out end 112A of the lower guide tube 112. It will be noted that lower pin 106 protrudes only from one side of the rod 100, thereby to permit rotation, as indicated by arrow A.

Another advantage associated with the recoil spring is associated with entry of the pin into the slot. Herein, it will be appreciated that, when the operator pivots the kick arm against the force of the spring, the spring will tend to compress lengthwise, such that, when the upper pin aligns with the groove, the spring will draw the pin slightly into the groove. This permits the operator to continue the extension of the landing gear.

Yet further variations are possible.

Accordingly, the invention should be understood as limited only by the accompanying claims, purposively construed.

1. An improved trailer of the type for use with a tractor,
the tractor being of the type having a fifth wheel movable between up and down positions,
the trailer being of the type having:
a wheeled carriage;
a king pin mounted to and extending downwardly from the underside of the carriage for coupling with the fifth wheel; and
a pair of landing gear, each of the pair including:
an elongate leg extending downwardly from the underside of the carriage and defining a longitudinal axis; and
a foot operatively mounted to the leg for longitudinal movement between a retracted position proximal to the leg and an extended position distal to the leg
wherein the improvement comprises:
an indexing member which, in use, is operatively connected to the leg;
a mounting structure which, in use, is operatively connected to the foot; and
a calibration structure connected to the mounting structure and which, in use, extends axially alongside the leg.

2. The trailer according to claim 1,
wherein, in respect of each of the landing gear:
said each landing gear has an operative configuration wherein: when the carriage is supported by the landing gear and the fifth wheel of the tractor is in the down position, the tractor can be driven underneath the carriage to permit smooth engagement and smooth disengagement of the fifth wheel and the king pin; and
when the fifth wheel and king pin are engaged, movement of the fifth wheel from the down position to the up position elevates the foot from the ground; and
the calibration structure has a sweet spot which is aligned with the indexing member when said each landing gear is in the operative configuration; and
further comprising a marker associated in use with the sweet spot and adapted to facilitate visual alignment of the sweet spot and the indexing member.

3. The trailer according to claim 2, wherein the marker is releasably connected to the sweet spot in use.

4. The trailer according to claim 3, wherein the calibration structure is a rod, the sweet spot is defined by a peripheral groove in the rod and the marker is a spring clip.

5. The trailer according to claim 1, wherein: the indexing member, in use, is connected to the leg; the mounting structure, in use, is connected to the foot; and the calibration structure is a rod.

6. Apparatus comprising:
a landing gear including:
a leg which extends downwardly in use and defines a longitudinal axis;
a foot operatively mounted to the leg for axial movement between a retracted position proximal to the leg and an extended position distal to the leg;
an indexing member which, in use, is operatively connected to the leg;
a mounting structure which, in use, is operatively connected to the foot; and
a calibration structure connected to the mounting structure and which, in use, extends axially alongside the leg.

7. Apparatus according to claim 6, further comprising a marker: adapted to facilitate visual alignment of the marker and the indexing member; and releasably connected to the calibration structure in use.

8. Apparatus according to claim 7, wherein
the calibration structure has a plurality of securement locations which are axially-spaced from one another in use; and
the marker is adapted for releasable connection to any selected one of the securement locations, thereby to provide for said releasable connection of the marker to the calibration structure in use.

9. A kit for use with a variety of trailer-tow vehicle combinations,
in each combination,
the tow vehicle having one of a hitch and a hitch receiver; and
the trailer having: the other of the hitch and the hitch receiver; and a landing gear, the landing gear including
an elongate leg extending downwardly from the trailer and defining a longitudinal axis; and
a foot operatively mounted to the leg for axial movement between a retracted position proximal to the leg and an extended position distal to the leg
the kit comprising:
an indexing member which, in use, is operatively connected to the leg of the landing gear of any one of the variety of trailers;
a mounting structure which, in use, is operatively connected to the foot of said landing gear;
a calibration structure: connected to the mounting structure; which, in use, extends axially alongside the leg of said landing gear; and having a plurality of axially-spaced securement locations associated therewith; and
a marker adapted: to facilitate visual alignment of the marker and the indexing member;
and for releasable connection to the calibration structure at any selected one of the securement locations,
whereby
in the context of the use of the kit with any one of the combinations, wherein
the landing gear of the trailer of said combination has an operative configuration wherein the trailer is supported by the landing gear such that other of the hitch and hitch receiver is at a height optimized for engagement of the one of the hitch and hitch receiver therewith,
the calibration structure has a sweet spot which is aligned with the indexing member when the landing gear is in the operative configuration,
the marker can be secured to the one of the securement locations closest to the sweet spot to facilitate visual alignment of the sweet spot with the indexing member, thereby to approximate the operative configuration of the landing gear and facilitate engagement and disengagement of the hitch and hitch receiver.

10. The kit according to claim 9, wherein the calibration structure is a rod, the securement locations are defined by respective peripheral grooves in the rod and the marker is a spring clip.
